(19) United States
(12) Patent Application Publication
(10) Pub. No.: US 2006/0065102 A1
(43) Pub. Date: Mar. 30, 2006

(54) Summarizing digital audio data

(76) Inventor: Changsheng Xu, Singapore (SG)

Correspondence Address: LADAS & PARRY, 26 WEST 61ST STREET, NEW YORK, NY, 10023, US

(21) Appl. No.: 10/536,700

(22) PCT Filed: Nov. 28, 2002
(86) PCT No.: PCT/SG02/00279

§ 371 Date: May 27, 2005

(51) Int. Cl. G10H 1/00

(52) U.S. Cl. 84/600

(57) ABSTRACT

An embodiment is related to automatic summarization for digital audio raw data (12), more specifically, for identifying pure music and vocal music (40,60) from digital audio data by extracting distinctive features from music frames (73,74,75,76), designing a classifier and determining the classification parameters (20) using adaptive learning/training algorithm (36), and identifying music into pure music or vocal music according to the classifier. For pure music, temporal, spectral and cepstral features are calculated to characterise the musical content, and an adaptive clustering method is used to structure the musical content according to calculated features. The summary (22,24,26,48,52,70,72) is created according to clustered result and domain-based music knowledge (50,150). For vocal music, voice related features are extracted and used to structure the musical content, and similarly, the music summary is created in terms of structured content and heuristic rules related to music genres.

### FIELD OF INVENTION

This invention relates to data analysis, such as audio data indexing and classification. More specifically, this invention relates to automatically summarizing digital music raw data for various applications, for example content-based music retrieval and web-based online music distribution.

### BACKGROUND

The rapid development of computer networks and multi-media technologies have resulted in a rapid increase of the size of digital multimedia data collections. In response to this development, there is a need for a concise and informative summary of vast multimedia data collections that best captures the essential elements of an original content in large-scale information organisation and processing. So far, a number of techniques have been proposed and developed to automatically create text, speech and video summaries. Music summarization, however, refers to determining the most common and salient themes of a given music that may be used as a representative of the music and readily recognised by a listener. Compared with text, speech and video summarization, music summarization provides a special challenge because raw digital music data is a featureless collection of bytes, which is only available in the form of highly unstructured monolithic sound files.

U.S. Pat. No. 6,225,546 issued on 1 May 2001 to International Business Machines Corporation relates to music summarization and discloses a summarization system for Musical Instrument Design Interface (MIDI) data format utilising the repetitious nature of MIDI compositions to automatically recognise the main melody theme segment of a given piece of music. A detection engine utilises algorithms that model melody recognition and music summarization problems as various string processing problems and processes the problems. The system recognises maximal length segments that have non-trivial repetitions in each track of the MIDI format of the musical piece. These segments are basic units of a music composition, and are the candidates for the melody in a music piece. However, MIDI format data is not sampled raw audio data, i.e., actual audio sounds. Instead, MIDI format data contains synthesiser instructions, or MIDI notes, to reproduce the audio data. Specifically, a synthesiser generates actual sounds from the instructions in a MIDI format data. Compared with actual audio sounds, MIDI data may not provide a common playback experience and an unlimited sound palette for both instruments and sound effects. On the other hand, MIDI data is a structured, format, which facilitates creation of a summary according to its structure. Therefore, MIDI summarization is not practical in real-time playback applications. Accordingly, a need exits for creating a music summary from real raw digital audio data.

The publication entitled “Music Summarization Using Key Phrases” by Beth Logan and Stephen Chu (IEEE International Conference on Audio, Speech and Signal processing, Orlando, USA, 2000, Vol. 2, pp. 749-752) discloses a method for summarizing music by parameterizing each song using “Mel-cepstral” features that have found a use in speech recognition applications. These features of speech recognition may be applied together with various clustering techniques to discover the song structure of a piece of music having vocals. Heuristics are then used to extract the key phrase given this structure. This summarization method is suitable for certain genres of music having vocals such as rock or folk music, but the method is less applicable to pure music or instrumental genres such as classical or jazz music. “Mel-cepstral” features may not uniquely reflect the characteristics of music content, especially pure music, for example instrumental music. Thus the summarization quality of this method is not acceptable for applications that require, in particular, music summarization of all types of music genres.

Therefore, there is a need for automatic music summarization of digital music raw data that may be applied to music indexing of all types of music genre for use in, for example, content-based music retrieval and web-based music distribution for real-time playback applications.

### SUMMARY

Embodiments of the invention provide automatic summarization of digital audio data, such as musical raw data that is inherently highly structured. An embodiment provides a summary for an audio file such as pure and/or vocal music, for example classical, jazz, pop, rock or instrumental music. Another feature of an embodiment is to use adaptive training algorithm to design a classifier to identify pure music and vocal music. Another feature of an embodiment is to create music summaries for pure and vocal music by structuring the musical content using an adaptive clustering algorithm and applying domain-based music knowledge. An embodiment provides automatic summarization for digital audio raw data for identifying pure music and vocal music from digital audio data by extracting distinctive features from music frames, designing a classifier and determining the classification parameters using adaptive learning/training algorithm, and identifying music into pure music or vocal music according to the classifier. For pure music, temporal, spectral and cepstral features are calculated to characterise the musical content, and an adaptive clustering method is used to structure the musical content according to calculated features. The summary is created according to clustered result and domain-based music knowledge. For vocal music, voice related features are extracted and used to structure the musical content, and similarly, the music summary is created in terms of structured content and heuristic rules related to music genres.

In accordance with an aspect of the invention, there is provided a method for summarizing digital audio data comprising the steps of analyzing the audio data to identify a representation of the audio data having at least one calculated feature characteristic of the audio data; classifying the audio data on the basis of the representation into a category selected from at least two categories; and generating an acoustic signal representative of a summarization of the digital audio data, wherein the summarization is dependent on the selected category.

In other embodiments the analyzing step may further comprise segmenting audio data into segment frames, and overlapping the frames, and/or the classifying step may further comprise classifying the frames into a category by collecting training data from each frame and determining classification parameters by using a training calculation.

In accordance with another aspect of the invention, there is provided an apparatus for summarizing digital audio data comprising a feature extractor for receiving audio data and analyzing the audio data to identify a representation of the audio data having at least one calculated feature characteristic of the audio data; a classifier in communication with the feature extractor for classifying the audio data on the basis of the representation received from the feature extractor into a category selected from at least two categories; and a summarizer in communication with the classifier for generating an acoustic signal representative of a summarization of the digital audio data, wherein the summarization is dependent on the category selected by the classifier.

In other embodiments, the apparatus may further comprise a segmentor in communication with the feature extractor for receiving an audio file and segmenting audio data into segment frames, and overlapping the frames for the feature extractor. The apparatus may further comprise a classification parameter generator in communication with the classifier, wherein the classifier classifies each of the frames into a category by collecting training data from each frame and determining classification parameters by using a training calculation in the classification parameter generator.

In accordance with yet a further aspect of the invention, there is provided a computer program product comprising a computer usable medium having computer readable program code means embodied in the medium for summarizing digital audio data, the computer program product comprising a computer readable program code means for analyzing the audio data to identify a representation of the audio data having at least one calculated feature characteristic of the audio data; a computer readable program code for classifying the audio data on the basis of the representation into a category selected from at least two categories; and a computer readable program code for generating an acoustic signal representative of a summarization of the digital audio data, wherein the summarization is dependent on the selected category.

### BRIEF DESCRIPTION OF THE DRAWINGS

These and other features, objects and advantages of embodiments of the present invention will be better understood and readily apparent to one of ordinary skill in the art from the following written description, in conjunction with drawings, in which:

FIG. 1 is a block diagram of a system used for generating an audio file summary in accordance with an embodiment of the invention;

FIG. 2 is a flow chart illustrating the method for generating an audio file summary in accordance with an embodiment of the invention;

FIG. 3 is a flow chart of a training process to produce the classification parameters of a classifier of FIGS. 1 and 2 in accordance with an embodiment of the invention;

FIG. 4 is a flow chart of the pure music summarization of FIG. 2 in more detail in accordance with an embodiment of the invention;

FIG. 5 illustrates a block diagram of a vocal music summarization of FIG. 2 in more detail in accordance with an embodiment of the invention;

FIG. 6 illustrates a graph representing segmentation of audio raw data into overlapping frames in accordance with an embodiment of the invention; and

FIG. 7 illustrates a two-dimensional representation of the distance matrix of the frames of FIG. 6 in accordance with an embodiment of the invention.

### DETAILED DESCRIPTION

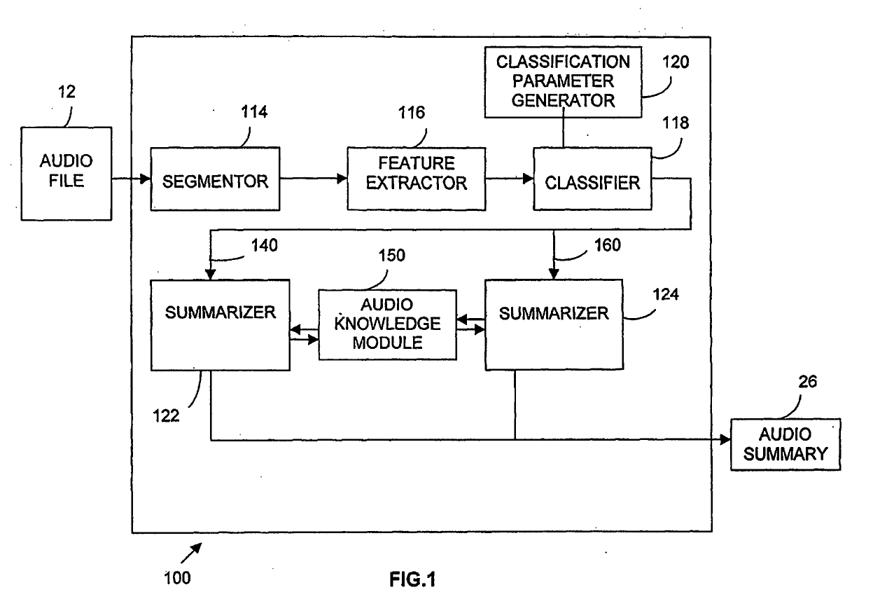

FIG. 1 is a block diagram illustrating the components and/or modules of a system 100 used for generating an audio summary in accordance with an embodiment of the invention. The system may receive an audio file such as music content 12 at a segmenter 114. The music sequence 12 is segmented into frames, and features are extracted at each frame at feature extractor 116. The classifier 118, on the basis of the classification parameters supplied from the classification parameter generator 120, classifies the feature-extracted frames into categories, such as pure music sequence 140 or vocal music sequence 160. Pure music is defined as the music content without singing voice and vocal music is defined as the music content with singing voice. An audio summary is generated at either of music summarizers 122 and 124 that perform a summarization of either the audio content designed specifically for the category the audio content was classified by classification 118, and may be calculated with the aid of information of specific categories of audio content resident in audio knowledge module or look up table 150. Two summarizers are shown in FIG. 1, however it will be appreciated that only one summarizer may be required for one type of audio file, for example if all the audio files only contain one type of music content, such as pure music or vocal music. FIG. 1 depicts two summarizers that may be implemented for example for two general types of music such as a pure music summarizer 122 and vocal music summarizer 124. The system then provides an audio sequence summary, for example music summary 26.

The embodiment depicted in FIG. 1, and the method discussed herewith may generally be implemented in and/or on computer architecture that is well known in the art. The functionality of the embodiments of the invention described may be implemented in either hardware or software. In the software sense components, of the system may be a process, program or portion thereof, that usually performs a particular function or related functions. In the hardware sense, a component is a functional hardware unit designed for use with other components. For example, a component may be implemented using discrete electrical components, or may form a portion of an entire electronic circuit such as an Application Specific Integrated Circuit (ASIC). There are numerous other possibilities that exist, and those skilled in the art would be able to appreciate that the system may also be implemented as a combination of hardware and software components.

Personal computers or servers are examples of computer architectures that embodiments may be implemented in or on. Such computer architectures comprise components and/or modules such as central processing units (CPU) with microprocessor, random access memory (RAM), read only memory (ROM) for temporary and permanent, respectively, storage of information, and mass storage device such as hard drive, diskette, or CD ROM and the like. Such computer architectures further contain a bus to interconnect the components and a controlled information and communication between the components. Additionally, user input and output interfaces are usually provided, such as a keyboard, mouse, microphone and the like for user input, and display, printer, speakers and the like for output. Generally, each of the input/output interfaces is connected to the bus by the controller and implemented with controller software. Of course, it will be apparent that any number of input/output devices may be implemented in such systems. The computer system is typically controlled and managed by operating system software resident on the CPU. There are a number of operating systems that are commonly available and well known. Thus, embodiments of the present invention may be implemented in and/or on such computer architectures.

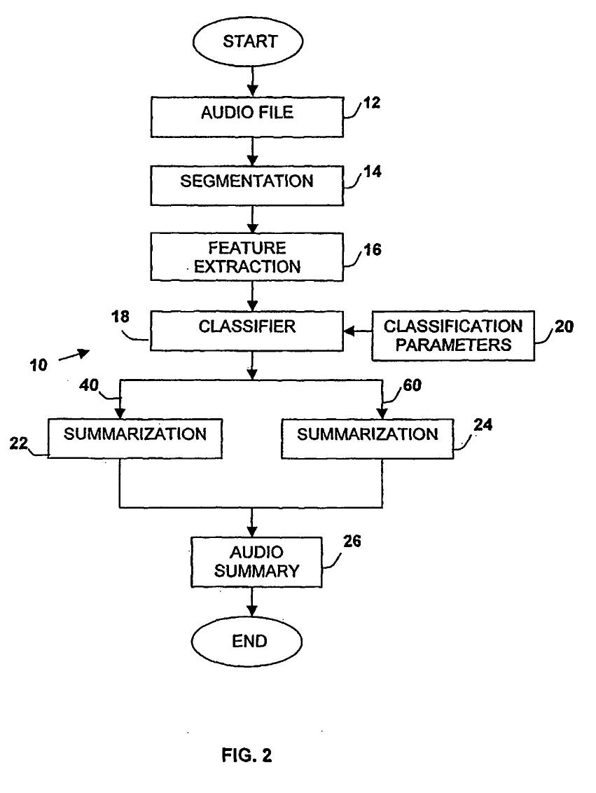

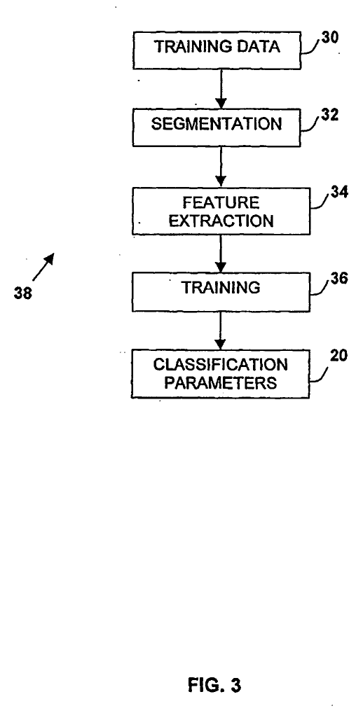

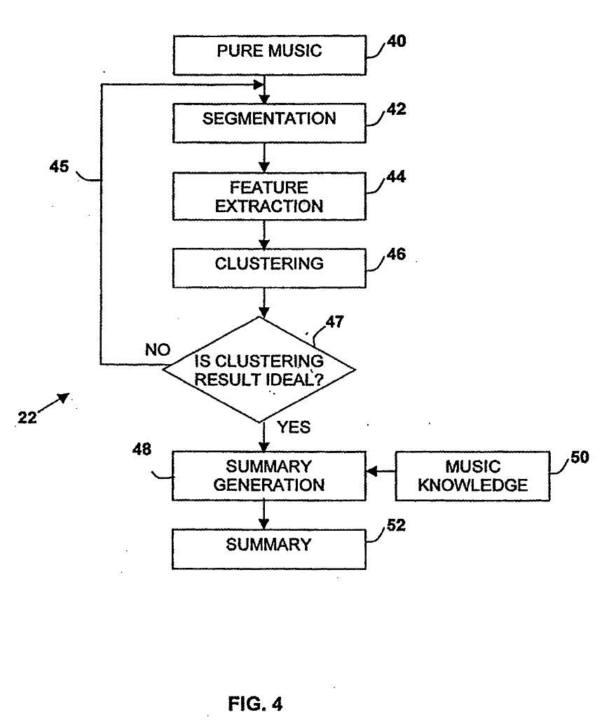

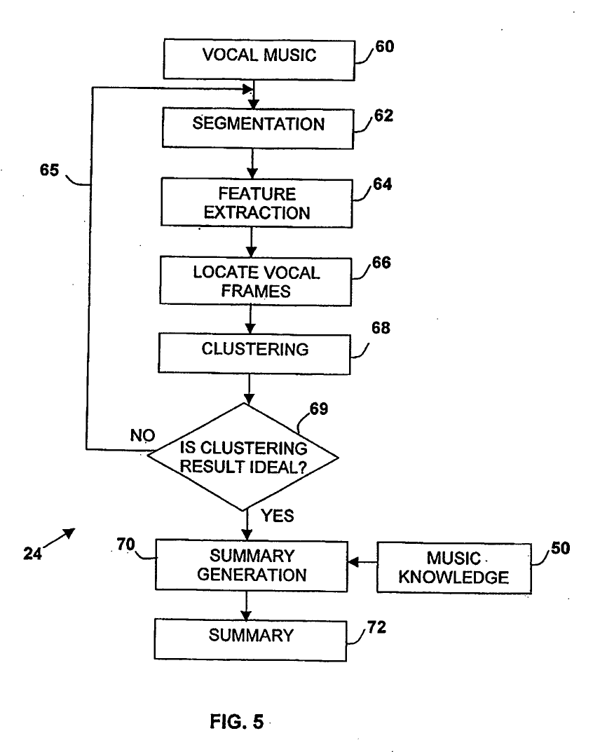

FIG. 2 illustrates block diagram of the components of the system and/or method 10 used for automatically creating an audio summary such as a music summary in accordance with an embodiment of the invention. This embodiment starts with receiving incoming audio data. The incoming audio data such as audio file 12 may comprise, for example, a music sequence or content. The music content is first segmented at segmentation step 14 into frames. Then, at feature extraction step 16 features such as, for example linear prediction coefficients, zero crossing rates and mel-frequency cepstral coefficients, are extracted and calculated together to form a feature vector of each frame to represent the characteristics of music content. The feature vector of each frame of the whole music sequence is passed through a classifier the music into categories, such as pure or vocal music. It will be appreciated that any number of categories may be used. The classification parameters 20 of the classifier 18 are determined by a training/classification process depicted in FIG. 3. Once classified into audio categories such as pure music 40 or vocal music 60 music categories, each category is then summarised to provide and end with an audio summary 26. For example, pure music summarization step 22 is shown in detail in FIG. 4. Likewise, vocal music summarization step 24 is shown in detail in FIG. 5.

FIG. 3 illustrates a conceptual block of a diagram of a training/classification parameter process 38 of an embodiment to produce classification parameters 20 of classifier 18 (shown in FIG. 2) in accordance with an embodiment of the invention. In order to identify a musical content into different categories, such as pure music or vocal music, a classifier 18 is provided. The classification parameters 20 for classifier 18 are determined by the training process 38. The training process analyses musical training sample data to find an optimal way to classify musical frames into classifications, such as for example, vocal 60 or non-vocal 40 classes. The training audio 30 should be sufficient to be statistically significant, for example the training data should originate from various sources and include various genres of music. The training sample audio data may also be segmented 32 into fixed-length and overlapping frames as discussed at segmentation 14 of FIG. 2. Features such as linear prediction coefficients, zero crossing rates and mel-frequency cepstral coefficients, etc., are extracted 34 from each frame. The features chosen for each frame are features that best characterise a classification, for example, features are chosen for vocal classes that best characterise vocal classes. The calculated features are clustered by a training algorithm 36 such as hidden Markov model, neural network, and support vector machine, etc., to produce the classification parameters 20. Any such training algorithms may be used, however, some training algorithms may be better suited for any particular application. For example, support vector machine training algorithm may perform good classification results, but the training time is long in comparison to other training algorithms. The training process needs to be performed only once, but may be performed any number of times. The derived classification parameters are used to identify different classifications of audio content, for example, non-vocal or pure music and vocal music.

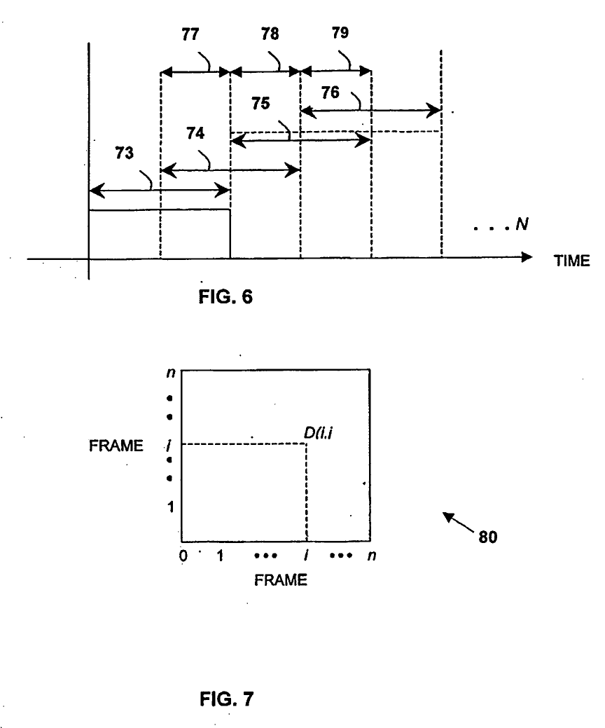

FIG. 4 illustrates a conceptual block diagram of an embodiment of the pure music summarization, and FIG. 5 illustrates a conceptual block diagram of an embodiment of the vocal music summarization. The aim of the summarization is to analyse a given audio data such as a music sequence and extract the important frames to reflect the salient theme of the music. Based on calculated features of each frame, an adaptive clustering method is used to group the music frames and the structure of the music content. Since the adjacent frames have overlap, the length of overlap is determined for frame grouping. In the initial stage, determining exactly the length of the overlap is difficult. The length of overlap may be adaptively adjusted if the clustering result is not ideal for frame grouping. An example of the general clustering algorithm is described as follows:
(1) Segment music signal, at segmenter 114 or segmentation step 42,62, as shown in FIG. 6, into N fixed-lengths 73,74,75,76 and provide overlapping frames 77,78,79, for example 50% as shown in FIG. 6, and label each frame with a number i(i=1,2, . . . N), the initial set of clusters is all frames. The segmentation process at steps 42,62 may also follow the same procedure of segmentation process performed at other occurances such as segmentation steps 14,32 as discussed above and shown in FIGS. 2 and 3;
(2) For each frame calculate feature extractions at feature extraction step 44,64 specific to the particular category of audio file, for example, the linear prediction coefficients, zero crossing rates, and mel-frequency cepstral coefficients to form a feature vector:
   \vec{V}ᵢ=(LPCᵢ,ZCRᵢ,MFCCᵢ) i=1,2, . . . , N (1)
where LPCᵢ denotes the linear prediction coefficients, ZCRᵢ denotes the zero crossing rates, and MFCCᵢ denotes the mel-frequency cepstral coefficients.
(3) Calculate the distances between every pair of music frames i and j using, for example, the Mahalanobis distance:
   D_{M}(\vec{V}ᵢ,\vec{V}ⱼ)=[\vec{V}ᵢ−\vec{V}ⱼ]R⁻¹[\vec{V}ᵢ−\vec{V}ⱼ]i≠j (2)
where R is the covariance matrix of the feature vector. Since R⁻¹ is symmetric, R⁻¹ is a semi or positive matrix. R⁻¹ may be diagonalized as R⁻¹=P^{T} ΛP, where Λ is a diagonal matrix and P is an orthogonal matrix. Equation (2) may be simplified in terms of Euclidean distance as follows:
   D_{M}(\vec{V}ᵢ,\vec{V}ⱼ)=D_{E}(\sqrt{Λ}P\vec{V}ᵢ,\sqrt{Λ}P\vec{V}ⱼ) (3)
Since Λ and P may be computed directly from R⁻¹, the complexity of the computation of the vector distance may be reduced from O(n²) to O(n).
(4) Embed the calculated distances into a two-dimensional representation 80 as shown in FIG. 7. The matrix S 80 contains the similarity metric calculated for all frame combinations, hence frame indexes i and j such that the i, jth element of S is D(i,j).
(5) For each row of two-dimensional matrix S, if the distance between any two frames is less than a pre-defined threshold, for example in this embodiment the predefined threshold is a value such as 1.0, then the frames are grouped into the same cluster.
(6) If the final clustering result result is not ideal, adjust the length of overlap of two frames and repeat step (2) to (5), as shown by arrow 45 in FIG. 4 and arrow 65 in FIG. 5. For example, in this embodiment, an ideal result means the number of clusters is much less than the number of initial clusters after the clustering. If the result is not ideal, then the overlap may be is adjusted by changing the overlapping length, for example, 50% to 40%.

Referring to the clustering for the specific categories, FIG. 4 depicts summarization process for pure/non-vocal music, and FIG. 5 depicts summarization process for vocal music. In FIG. 4, the pure music content 40 is first segmented 42 into lengths, for example, fixed-length and overlapping frames as discussed above and then feature extraction 44 is conducted in each frame as discussed above. The extracted features may include amplitude envelopes, power spectrum, mel-frequency cepstral coefficients, etc., which may characterise pure music content in temporal, spectral and cepstral domains. It will be appreciated that other features may be extracted to characterise pure music content and this is not limited to the features listed here. Based on calculated features, an adaptive clustering 46 algorithm is applied to group the frames and get the structure of the music content. The segmentation and adaptive clustering algorithm may be the same as above. For example, if the clustering result is not ideal at decision step 47, 69 after the first pass, the segmentation step 42,62 and feature extraction step 44,64 are repeated with the frames having different overlapping relationship. This process is repeated at querying step 47, 69 as shown by arrow 45, 65 until a desired clustering result is achieved. After clustering, frames with similar features are grouped into the same clusters which represent the structure of the music content. Summary generation 48 is then performed in terms of this structure and domain-based music knowledge 50. According to music knowledge, the most distinctive or representative musical themes should repetitively occur in an entire music work.

The length of the summary 52 should be long enough to represent the most distinctive or representative expert of the whole music. Usually, for a three to four minute piece of music, 30 seconds is a proper length of the summary. An example to generate the summary of a music work is described as follows:
(1) Identify the cluster including the maximal amount of frames. The labels of these frames are f₁, f₂, . . . fₙ, where f₁<f₂< . . . <fₙ;
(2) From these frames, select the frame with the smallest label fᵢ according to following rule:
For m=1 to k
If frame (fᵢ+m) and frame (fⱼ+m) belong to the same cluster, i,j∈[1,n], i<j,k is the number to determine the length of the summary;
(3) Frames (fᵢ+1), (fᵢ+2), . . . , (fᵢ+k) are the final summary of the music.

FIG. 5 illustrates a conceptual block diagram of the vocal music summarization in accordance with an embodiment. The vocal music content 60 is first segmented 62 into fixed-length and overlapping frames which may be performed in the same manner as discussed above. The features extraction 64 is conducted in each frame. The extracted features include linear prediction coefficients, zero crossing rates, mel-frequency cepstral coefficients, etc., which may characterise vocal music content. Of course, as discussed above with respect to non-vocal music, it will be appreciated that other features may be extracted to characterise vocal music content and is not limited by the features listed here. Based on the calculated features, vocal frames 66 are located and other non-vocal frames are discarded. An adaptive clustering algorithm 68 is applied to group these vocal frame and get the structure of the vocal music content. The segmentation and adaptive clustering algorithm may be the same as above, for example, if the clustering result is not ideal, the segmentation step 62 and feature extraction step 64 are repeated with the frames having a different overlap relationship. The process is repeated, as shown by decision step 69 and branch 65 in FIG. 5, until a desired clustering result is achieved. Finally, music summary 70 is created based on clustered results and music knowledge 50 relevant to vocal music.

The summarization process 72 for vocal music is similar to that of pure music, but there are several differences, that may be stored as music knowledge 50, for example, music knowledge module or look up table 150 in FIG. 1. The first difference is feature extraction. For pure music, power-related features such as amplitude envelope and power spectrum are used since voice-related features may better represent the characteristics of pure music content. Amplitude envelope is calculated in time domain, while spectrum power is calculated in frequency domain. For vocal music, voice-related features such as linear prediction coefficients, zero crossing rate and mel-frequency cepstral coefficients are used since they may better represent the characteristics of vocal music content.

Another difference between pure music and vocal music summarization process is the summary generation. For pure music, the summary is still pure music. But for vocal music, the summary should start with vocal part and it is desirable to have the music title sung in the summary. There are some other rules relevant to music genres, that may be stored as music knowledge 50. In pop and rock music, for example, the main melody part repeats typically in the same way without major variations. The pop and rock music usually follows a similar scheme or pattern, for example ABAB format where A represents a verse and B represents a refrain. The main theme (refrain) part occurs the most frequently, followed by the verse, bridge and so on. However, jazz music usually comprises the improvisation of the musicians, producing variations in most of the parts and creating problems in determining the main melody part. Since there is typically no refrain in jazz music, the main part in jazz music is the verse.

In essence, an embodiment of the present invention stems from the realisation that a representation of musical information, which includes a characteristic relative difference value, provides a relatively concise and characteristic means of representing, indexing and/or retrieving musical information. It has also been found that these relative difference values provide a relatively non-complex structure representation for unstructured monolithic musical raw digital data.

In the forgoing manner, a method, a system and a computer program product for providing a summarization of digital audio raw data are disclosed. Only several embodiments are described. However, it will be apparent to one skilled in the art in view of this disclosure that numerous changes and/or modifications may be made without departing from the scope of the invention.

1. A method of summarizing digital audio data comprising the steps of:
directly analyzing the audio data to identify a representation of the audio data having at least one calculated feature characteristic of the audio data;
classifying the audio data on the basis of the representation into a category selected from at least two categories; and
generating an acoustic signal representative of a summarization of the digital audio data, wherein the summarization is dependent on the selected category.

2. A method as claimed in claim 1, wherein the analyzing step further comprises segmenting audio data into segment frames, and overlapping the frames.

3. A method as claimed in claim 2, wherein the classifying step further comprises classifying the frames into a category by collecting training data from each frame and determining classification parameters by using a training calculation.

4. A method as claimed in claims 1, wherein the calculated feature comprises perceptual and subjective features related to music content.

5. A method as claimed in claim 3, wherein the training calculation comprises a statistical learning algorithm wherein the statistical learning algorithm is Hidden Markov Model, Neural Network, or Support Vector Machine.

6. A method as claimed in claims 1, wherein the type of acoustic signal is music.

7. A method as claimed in claims 1, wherein the type of acoustic signal is vocal music or pure music.

8. A method as claimed in claims 1, wherein the calculated feature is amplitude envelope, power spectrum or mel-frequency cepstral coefficients.

9. A method as claimed in claims 1, wherein the summarization is generated in terms of clustered results and heuristic rules related to pure or vocal music.

10. A method as claimed in claims 1, wherein the calculated feature relates to pure or vocal music content and is linear prediction coefficients, zero crossing rates, or mel-frequency cepstral coefficients.

11. An apparatus for summarizing digital audio data comprising:
a feature extractor for receiving audio data and directly analyzing the audio data to identify a representation of the audio data having at least one calculated feature characteristic of the audio data;
a classifier in communication with the feature extractor for classifying the audio data on the basis of the representation received from the feature extractor into a category selected from at least two categories; and
a summarizer in communication with the classifier for generating an acoustic signal representative of a summarization of the digital audio data, wherein the summarization is dependent on the category selected by the classifier.

12. An apparatus as claimed in claim 11, further comprising a segmentor in communication with the feature extractor for receiving an audio file and segmenting audio data into segment frames, and overlapping the frames for the feature extractor.

13. An apparatus as claimed in claim 12, further comprising a classification parameter generator in communication with the classifier, wherein the classifier classifies each of the frames into a category by collecting training data from each frame and determining classification parameters by using a training calculation in the classification parameter generator.

14. An apparatus as claimed in claim 11, wherein the calculated feature comprises perceptual and subjective features related to music content.

15. An apparatus as claimed in claim 11, wherein the training calculation comprises a statistical learning algorithm wherein the statistical learning algorithm is Hidden Markov Model, Neural Network, or Support Vector Machine.

16. An apparatus as claimed in claim 11, wherein the acoustic signal is music.

17. An apparatus as claimed in claim 11, wherein the acoustic signal is vocal music or pure music.

18. An apparatus as claimed in claim 11, wherein the calculated feature is amplitude envelope, power spectrum or mel-frequency cepstral coefficients.

19. An apparatus as claimed in claim 11, wherein the summarizer generates the summarization in terms of clustered results and heuristic rules related to pure or vocal music.

20. An apparatus as claimed in claim 11, wherein the calculated feature relates to pure or vocal music content and is linear prediction coefficients, zero crossing rates, or mel-frequency.

21. A computer program product for summarizing digital audio data comprising a computer usable medium having computer readable program code means embodied in said medium for causing the summarizing of digital audio data, said computer program product comprising:
a computer readable program code means for directly analyzing the audio data to identify a representation of the audio data having at least one calculated feature characteristic of the audio data;
a computer readable program code for classifying the audio data on the basis of the representation into a category selected from at least two categories; and
a computer readable program code for generating an acoustic signal representative of a summarization of the digital audio data, wherein the summarization is dependent on the selected category.

22. A computer program product as claimed in claim 21, wherein analyzing further comprises segmenting audio data into segment frames, and overlapping the frames.

23. A computer program product as claimed in claim 22, wherein classifying further comprises classifying the frames into a category by collecting training data from each frame and determining classification parameters by using a training calculation.

24. A computer program product as claimed in claim 21, wherein the calculated feature comprises perceptual and subjective features related to music content.

25. A computer program product as claimed in claim 21, wherein the training calculation comprises a statistical learning algorithm wherein the statistical learning algorithm is Hidden Markov Model, Neural Network, or Support Vector Machine.

26. A computer program product as claimed in claim 21, wherein the acoustic signal is music.

27. A computer program product as claimed in claim 21, wherein the type of acoustic signal is vocal music or pure music.

28. A computer program product as claimed in claim 21, wherein the calculated feature is amplitude envelope, power spectrum or mel-frequency cepstral coefficients.

29. A computer program product as claimed in claim 21, wherein the summarization is generated in terms of clustered results and heuristic rules related to pure or vocal music.

30. A computer program product as claimed in claim 21, wherein the calculated feature relates to pure or vocal music content and is linear prediction coefficients, zero crossing rates, or mel-frequency.
